(19) United States
(12) Patent Application Publication
(10) Pub. No.: US 2019/0084559 A1
(43) Pub. Date: Mar. 21, 2019

(54) VEHICLE CONTROL DEVICE AND METHOD THEREFOR

(71) Applicant: MANDO CORPORATION, Pyeongtaek-si (KR)

(72) Inventor: Sang Kyun SIM, Anyang-si (KR)

(21) Appl. No.: 16/135,744

(22) Filed: Sep. 19, 2018

(30) Foreign Application Priority Data
Sep. 21, 2017 (KR) 10-2017-0121601

(51) Int. Cl. B60W 30/09; G01C 21/20; G05D 1/02

(52) U.S. Cl. CPC B60W 30/09; G01C 21/20; B60W 2550/10; G05D 2201/0213; B60W 2550/22; G05D 1/0214

(57) ABSTRACT

A vehicle control device includes a driving path calculator configured to calculate a driving path of a vehicle based on road attribute information including at least one piece of information from among road type information, obstacle information, and drivable road width information; an approaching vehicle detector configured to detect an approaching vehicle which moves in a direction opposite to a direction in which the vehicle drives, in the driving path while the vehicle drives along the driving path; a driving path change necessity determiner configured to determine a necessity of changing the driving path of the vehicle based on the road attribute information and an approaching vehicle's intention to change a path; and a vehicle movement controller configured to control a movement of the vehicle based on a result of determining the necessity of changing the driving path.

### CROSS REFERENCE TO RELATED APPLICATION

This application claims priority from Korean Patent Application No. 10-2017-0121601, filed on Sep. 21, 2017, which is hereby incorporated by reference for all purposes as if fully set forth herein.

### BACKGROUND OF THE INVENTION

### 1. Field of the Invention

The present disclosure relates to a method and apparatus for controlling a driving operation of a vehicle. Particularly, the present disclosure relates to a control device and a method therefor, which control a vehicle that avoids an approaching vehicle and drives with minimized driver's control.

### 2. Description of the Prior Art

Recently, there has been increasing research on autonomous driving technologies for minimizing drivers' steering control and speed control so as to maximize the convenience for drivers.

For an autonomous vehicle, it is important to minimize the number of times that a driver makes decisions and intervenes in the operation of a vehicle, and the most important issue is to gain the trust of drivers.

Particularly, on a narrow road, such as a one-way road or an alley, the autonomous vehicle may detect an obstacle or an approaching vehicle while driving, and cannot proceed with driving. In this instance, the autonomous vehicle needs to correct a driving path, so as to continuously perform autonomous driving.

However, when an approaching vehicle exists, the situation in which the vehicle sets a driving path to avoid the approaching vehicle may be inconvenient for a driver, and may also decrease the trust in the autonomous driving technologies, which is a drawback.

Therefore, there is a desire for a technology that continues autonomous driving and maintains the convenience and trust of a driver, by checking a predetermined condition when the autonomous vehicle meets a situation that does not allow the autonomous vehicle to drive along a driving path.

### SUMMARY OF THE INVENTION

In this background, an aspect of the present disclosure is to provide a vehicle control device and method, which detect the entry of an approaching vehicle while a vehicle drives along a set driving path, and changes or continues along the driving path by detecting an approaching vehicle's intention to change a path.

Another aspect of the present disclosure is to provide an autonomous vehicle control device and method, which determines whether to change a driving path by reflecting priority to drive, so as to improve the trust of a driver.

In accordance with an aspect of the present disclosure, there is provided a vehicle control device. The vehicle control device includes: a driving path calculator configured to calculate a driving path of a vehicle based on road attribute information including at least one piece of information from among road type information, obstacle information, and drivable road width information; an approaching vehicle detector configured to detect an approaching vehicle which moves in a direction opposite to a direction in which the vehicle drives, in the driving path while the vehicle drives along the driving path; a driving path change necessity determiner configured to determine a necessity of changing the driving path of the vehicle based on the road attribute information and an approaching vehicle's intention to change a path; and a vehicle movement controller configured to control a movement of the vehicle based on a result of determining the necessity of changing the driving path.

In accordance with an aspect of the present disclosure, there is provided a vehicle control method. The vehicle control method includes: a driving path calculation operation to calculate a driving path of a vehicle based on road attribute information including at least one piece of information from among road type information, obstacle information, and drivable road width information; an approaching vehicle detection operation to detect an approaching vehicle that moves in a direction opposite to a direction in which the vehicle travels, in the driving path while the vehicle travels along the driving path; a driving path change necessity determination operation to determine a necessity of changing the driving path of the vehicle based on the road attribute information and an approaching vehicle's intention to change a path;

and a vehicle movement control operation to control a movement of the vehicle based on a result of determining the necessity of changing the driving path.

According to an embodiment, when an autonomous vehicle is in a predetermined condition, the autonomous vehicle can continue autonomous driving control and maintain the convenience and trust of a driver.

According to an embodiment, a driving path may be changed or set by applying priority to drive based on a road type, whereby a vehicle control may be performed, which is similar to a vehicle control performed by a driver.

### BRIEF DESCRIPTION OF THE DRAWINGS

The above and other aspects, features and advantages of the present disclosure will be more apparent from the following detailed description taken in conjunction with the accompanying drawings, in which:

FIG. 1 is a diagram illustrating a situation in which an approaching vehicle appears, to which an embodiment is applied.

FIG. 2 is a diagram illustrating the configuration of a vehicle control device according to an embodiment.

FIG. 3 is a diagram illustrating an operation of determining an approaching vehicle's intention to change a path according to an embodiment.

FIG. 4 is a diagram illustrating operation of a vehicle control device according to an embodiment.

FIG. 5 is a diagram illustrating an operation of calculating an evasive driving path according to an embodiment.

FIG. 6 is a diagram illustrating an operation of controlling a movement of a vehicle according to an evasive driving path according to an embodiment.

FIG. 7 is a diagram illustrating a vehicle control method according to an embodiment.

### DETAILED DESCRIPTION OF THE EXEMPLARY EMBODIMENTS

The present disclosure discloses a vehicle control device and method.

Hereinafter, embodiments of the present disclosure will be described in detail with reference to the accompanying drawings. In the description of the elements of the present disclosure, terms “first”, “second”, “A”, “B”, “(a)”, “(b)” and the like may be used. These terms are merely used to distinguish one structural element from other structural elements, and a property, an order, a sequence and the like of a corresponding structural element are not limited by the team. It should be noted that if it is described in the specification that one component is “connected,” “coupled” or “joined” to another component, a third component may be “connected,” “coupled,” and “joined” between the first and second components, although the first component may be directly connected, coupled or joined to the second component.

In the present specification, the vehicle control device indicates a control unit for controlling a movement of a vehicle. For example, the vehicle control device may indicate a main control unit (MCU) or a CPU of the vehicle, or may indicate some functions of the MCU or the CPU. A vehicle control function controlled by the vehicle control device may include vehicle steering control, vehicle speed control, and the like, and may generate and transmit a signal for controlling each component of the vehicle such that the vehicle drives along a calculated driving path.

Also, the vehicle control device may obtain various pieces of sensing information from sensors included inside or outside the vehicle, and may calculate a driving path of the vehicle or the like using the obtained sensing information. Also, the vehicle control device may generate a control signal for controlling operation of each sensor and may transmit the same to a corresponding sensor.

The vehicle may include various sensors, such as an ultrasonic sensor, a radar sensor, a lidar sensor, a camera sensor, a torque sensor, a steering angle sensor, a vehicle speed sensor, and the like. In the present specification, the type of sensor for obtaining predetermined information is not limited. Also, the vehicle may include various devices for receiving information from the outside of the vehicle, and transmitting information to the outside of the vehicle. For example, the vehicle may obtain information associated with a road on which the vehicle is travelling via a device such as a navigation system or the like. Also, the vehicle may obtain information associated with the location where the vehicle drives, using a GPS sensor or the like included in the navigation system.

As a plurality of sensors are installed in a vehicle, research on autonomous driving technologies have been actively conducted, which minimizes steering control or vehicle speed control by a driver. For example, a lane keeping system that enables a vehicle to keep in a lane according to a degree of intervention by a driver, a smart cruise system that controls steering and vehicle speed of a vehicle by following another vehicle in front of the vehicle, or the like have been adapted and used.

Also, research has been conducted on autonomous driving technologies which calculate a path to a set destination, and enable a vehicle to autonomously drive to the destination without intervention by a driver.

In this instance, when the vehicle autonomously drives without intervention of a driver, various situations that may occur on a road need to be identified and the result of the identification needs to be reflected in vehicle movement control. For example, while an autonomous vehicle drives along a driving path, when the autonomous vehicle drives in a section that satisfies a predetermined road condition, such as a one-way road, and an approaching vehicle enters the section breaking traffic rules, if the vehicle unquestioningly sets an evasive path, the trust of a driver in an autonomous driving function may be decreased and the convenience for the driver may be decreased, whereby the frequency of use of the autonomous driving function may be reduced.

Therefore, hereinafter, an apparatus for minimizing the above-described drawbacks and for maintaining autonomous driving will be described with reference to drawings. In the present specification, descriptions will be provided by referring to a vehicle that drives with minimized intervention by a driver, as a “vehicle,” and an autonomous vehicle is included in the scope of a vehicle described in the present specification. Also, embodiments disclosed in the present disclosure may be applied to an autonomous vehicle, and may be set as a predetermined function and may be applied to a vehicle which is different from an autonomous vehicle. That is, the embodiments may be applied to an autonomous vehicle that does not need intervention by a driver, and may also be applied to a vehicle as a function although the vehicle needs intervention by a driver.

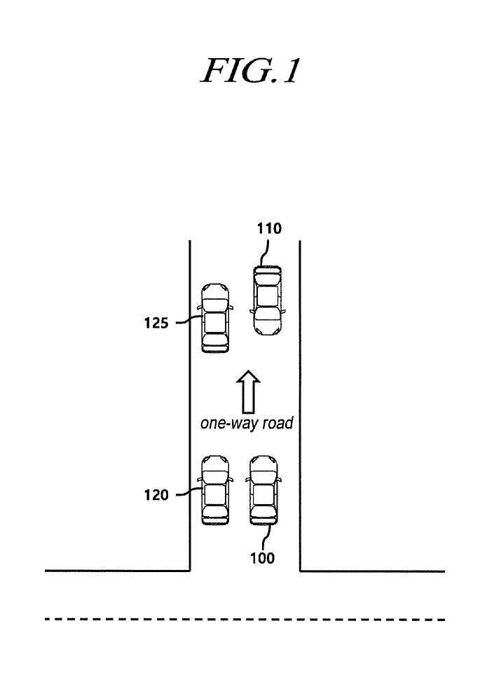

FIG. 1 is a diagram illustrating a situation in which an approaching vehicle appears, to which an embodiment is applied.

Referring to FIG. 1, a vehicle 100 may drive along a set driving path. For example, when a one-way road exists in the driving path of the vehicle 100, the vehicle 100 may drive along the one-way road. When other vehicles 120 and 125 parked in the one-way road exist, or when the one-way road is narrow and an approaching vehicle 110 is detected, the vehicle 100 may not continue driving. In this instance, the vehicle 100 may terminate an autonomous driving mode, and may request a driver to intervene in controlling the vehicle 100.

However, the situation may occur on a narrow road that allows only one vehicle to pass, such as an alley, as well as a one-way road, and may occur on a road that temporarily narrows due to an illegally parked vehicle.

Therefore, when the vehicle 100 recognizes the above-described situation and terminates an autonomous driving mode, the autonomous driving mode may be frequently terminated, which may cause inconvenience to a driver. Also, the trust of a driver in the autonomous driving mode may decrease and thus, the frequency of use of the autonomous driving mode may be dramatically decreased, which is a drawback.

Therefore, hereinafter, vehicle control technologies which enable a vehicle to maintain autonomous driving in various environments will be described. Hereinafter, descriptions will be provided based on a case in which the vehicle 100 detects the approaching vehicle 110 while driving on a one-way road. However, as described above, the embodiments will be equally applied even though the vehicle is incapable of driving due to a narrow road or the approaching vehicle 110.

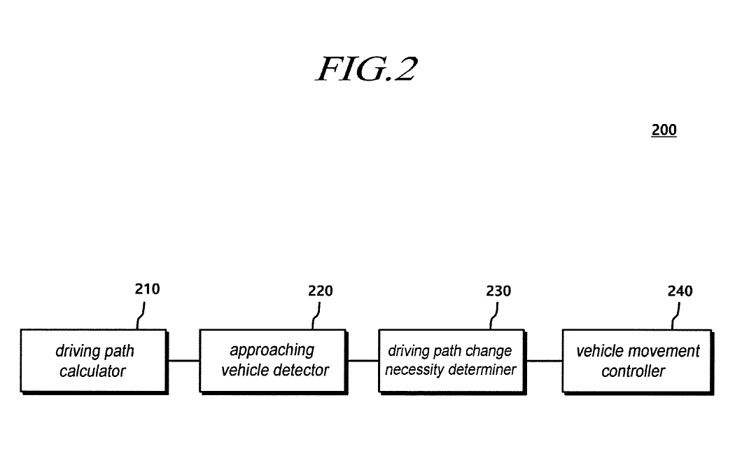

FIG. 2 is a diagram illustrating the configuration of a vehicle control device according to an embodiment.

Referring to FIG. 2, a vehicle control device 200 according to an embodiment may include: a driving path calculator 210 configured to calculate a driving path of a vehicle based on road attribute information including at least one piece of information from among road type information, obstacle information, and drivable road width information; an approaching vehicle detector 220 configured to detect an approaching vehicle that moves in a direction opposite to a direction in which the vehicle drives, in the driving path, while the vehicle drives along the driving path; a driving path change necessity determiner 230 configured to determine a necessity of changing the driving path of the vehicle based on the road attribute information and an approaching vehicle's intention to change a path; and a vehicle movement controller 240 configured to control a movement of the vehicle based on a result of determining the necessity of changing the driving path.

For example, the driving path calculator 210 may obtain obstacle information around the vehicle via an obstacle detection sensor installed in the vehicle. For example, the obstacle detection sensor may be an ultrasonic sensor, a radar sensor, a lidar sensor, a camera sensor, and the like. Alternatively, the vehicle may receive and obtain obstacle information from a neighboring vehicle or an infrastructural device via a communication device. Alternatively, road type information and drivable road width information may be obtained in association with the location of the vehicle via a communication device such as a navigation system of the vehicle. Particularly, the road type information may include information associated with whether a road on which the vehicle drives is a one-way road, a highway, or an alley. Also, the road type information may include road width information associated with the road.

The drivable road width information may be obtained using road type information and obstacle information. For example, when the road on which the vehicle drives is a road having a width that allows two vehicles to pass, and a parked vehicle or an obstacle exists, a drivable road width may be reduced. Therefore, the vehicle may calculate and obtain drivable road width information using the road width information of the corresponding road and obstacle size information.

The driving path calculator 210 may calculate a driving path of the vehicle using the obtained road attribute information. The driving path calculator 210 may calculate the driving path of the vehicle such that the vehicle avoids obstacles and safely drives on the corresponding road. To this end, the driving path calculator 210 may need location information of the vehicle, road attribute information, mobile obstacle information, and the like. In the present embodiments, a method of calculating a driving path is not limited to a specific technology, and various publicly known technologies can be applied.

The approaching vehicle detector 220 may detect a neighboring vehicle that moves in a direction in which the vehicle drives, in front of the vehicle, while the vehicle drives along the driving path. For example, the approaching vehicle detector 220 may detect the neighboring vehicle in front of the vehicle via a radar sensor of the vehicle, and may determine that the neighboring vehicle as an approaching vehicle when the distance between the vehicle and the neighboring vehicle in front of the vehicle becomes close during a predetermined period of time. Alternatively, the approaching vehicle detector 220 may detect a neighboring vehicle in front of the vehicle via a camera sensor, and may detect whether the neighboring vehicle is an approaching vehicle by analyzing a detection image associated with the neighboring vehicle. Alternatively, the approaching vehicle detector 220 may detect light of the headlights of an approaching vehicle using an illumination sensor or the like installed in the vehicle, and may detect the vehicle as an approaching vehicle when the level of illumination of the light is greater than or equal to a reference illumination. Alternatively, the approaching vehicle detector 220 may extract the shape of light of the headlights of a neighboring vehicle in front of the vehicle, and may detect the neighboring vehicle as an approaching vehicle when the shape of light corresponds to a reference shape (e.g., a circle in size greater than or equal to a predetermined size). The approaching vehicle is a neighboring vehicle that drives in a direction opposite to the direction in which the vehicle drives, and thus, the probability of a collision with the vehicle is high.

The driving path change necessity determiner 230 may determine road attribute information and an approaching vehicle's intention to change a path, so as to determine whether to change the driving path of the vehicle.

For example, when drivable road width information included in the road attribute information is greater than a sum of the width of the vehicle and the width of an approaching vehicle, the vehicle and the approaching vehicle are allowed to drive in parallel. Therefore, in this instance, the driving path change necessity determiner 230 may determine that the vehicle does not need to change the driving path. However, when the approaching vehicle drives in the lane in which the vehicle drives, the driving path change necessity determiner 230 may determine that the vehicle needs to change the driving path.

As another example, when it is determined that the road type information included in the road attribute information is a one-way road, the driving path change necessity determiner 230 may determine that the vehicle needs to change the driving path.

As another example, when it is determined that the road type information included in the road attribute information is a one-way road, and the vehicle drives in the wrong direction on the one-way road, the driving path change necessity determiner 230 may determine that the vehicle needs to change the driving path. In this instance, the driving path change necessity determiner 230 may determine that the vehicle needs to change the driving path, irrespective of whether an approaching vehicle intends to change a path.

As another example, when the road type is different from a one-way road and an approaching vehicle's intention to change a path is not detected, the driving path change necessity determiner 230 may determine that the vehicle needs to change the driving path.

As another example, when the road type is a one-way road but an approaching vehicle's intention to change a path is detected, the driving path change necessity determiner 230 may determine that the vehicle does not need to change the driving path. When the approaching vehicle changes the driving path, the user vehicle that has priority to pass through the one-way road can drive without changing the driving path of the user vehicle. Through the above, the trust of a driver in the autonomous driving mode may be improved.

As another example, when it is determined that an approaching vehicle's intention to change a path is detected, irrespective of a road type, the driving path change necessity determiner 230 may determine that the vehicle does not need to change the driving path. In this instance, since the approaching vehicle changes the driving path, the user vehicle is allowed to pass.

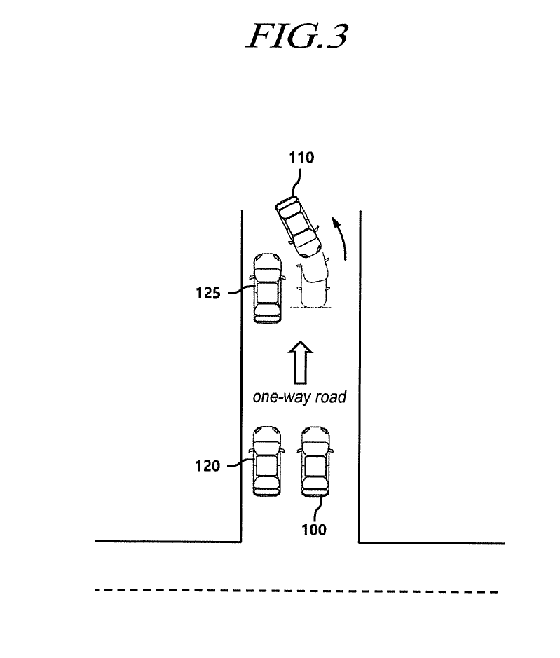

FIG. 3 is a diagram illustrating an operation of determining an approaching vehicle's intention to change a path according to an embodiment.

Referring to FIG. 3, an approaching vehicle 110's intention to change a path may be identified by detecting whether the approaching vehicle 110 reverses. When the vehicle 100 is not allowed to pass through a one-way road or a narrow road due to the approaching vehicle 110, a predetermined vehicle may need to change a driving path and to make an evasive movement.

For example, the driving path change necessity determiner 230 may determine whether the approaching vehicle 110 reverses using a variation in size of the approaching vehicle 110 sensed by a sensor. When the approaching vehicle 110 performs a reverse control and the driving path of the vehicle 100 is secured as illustrated in FIG. 3, the size of the approaching vehicle 110 in an image obtained via a camera sensor or the like may be continuously reduced during a predetermined period of time. Therefore, the driving path change necessity determiner 230 may determine whether the approaching vehicle 110 intends to change the path using a variation in size of the approaching vehicle 110. Although descriptions have been provided based on the size of the whole approaching vehicle 110, the embodiment may be equally applied when a variation in size of a part detected from the approaching vehicle 110 (e.g., a headlight, bumper, wind glass, or the like) is used.

Alternatively, the driving path change necessity determiner 230 may obtain information associated with speed at which the vehicle 100 drives and may reflect a component associated with the driving speed of the vehicle 100 when determining a variation in size of the approaching vehicle 110. For example, the driving path change necessity determiner 230 may detect whether the approaching vehicle 110 reverses, by further using the speed information of the vehicle 100. For example, a reference size variation, which is used for determining whether the approaching vehicle 110 reverses, may be differentially set for each speed information of the vehicle 100. That is, although a variation in size of the approaching vehicle 110 is less than a reference size variation, which is a predetermined criterion for determining an intention to reverse, when the vehicle 100 moves forward at a constant speed, the driving path change necessity determiner 230 may apply a reference size variation based on the speed, and may determine whether the approaching vehicle 110 reverses.

Alternatively, when the speed at which the vehicle 100 moves forward is the same as the speed at which the approaching vehicle 110 reverses, there may be no variation in size. Therefore, the driving path change necessity determiner 230 may reflect the speed information of the vehicle 100 and may determine that the approaching vehicle 110 reverses even when the size of the approaching vehicle 110 does not change. That is, the driving path change necessity determiner 230 may determine whether the approaching vehicle 110 intends to change the path using the vehicle speed of the vehicle 100 and a variation in size of the approaching vehicle 110. As another example, the driving path change necessity determiner 230 may determine whether the approaching vehicle 110 intends to change the driving path using a variation in the separation distance between the vehicle 100 and the approaching vehicle 110 obtained via a radar sensor or an ultrasonic sensor. When the approaching vehicle 110 reverses, the separation distance with the vehicle 100 may increase. Also, the driving path change necessity determiner 230 may determine whether the approaching vehicle 110 intends to change the driving path using the vehicle speed of the vehicle 100 and a variation in the separation distance between the vehicle 100 and the approaching vehicle 110. When the vehicle 100 moves forward and the separation distance between the vehicle 100 and the approaching vehicle 110 is not reduced, it may be determined that the approaching vehicle 110 reverses.

As another example, the driving path change necessity determiner 230 may detect a direction in which the approaching vehicle 110 moves and may determine whether the vehicle 100 needs to change the driving path. For example, the approaching vehicle 110 moves forward, and moves to a site between the parked vehicles 125 and 120. In this instance, although the approaching vehicle 110 does not reverse, it may be determined that the approaching vehicle 110 intends to change the driving path. When the approaching vehicle 110 moves to the site between the parked vehicles 120 and 125, the vehicle 100 may not need to change the driving path.

As another example, when an evasion space calculated based on road obstacle information exists and it is detected that the approaching vehicle 110 moves to the evasion space, the driving path change necessity determiner 230 may determine that the approaching vehicle 110 intends to change the driving path. In this instance, the direction in which the approaching vehicle 110 moves is not important. That is, either way, whether the approaching vehicle 110 moves forward and moves into an evasion space, or the approaching vehicle 110 reverses to move into an evasion space, is that the approaching vehicle 110 makes a detour, and thus, the driving path change necessity determiner 230 may determine that the approaching vehicle 110 intends to change the driving path. The evasion space may be calculated in advance in order to set a driving path, an evasive path, or the like for the vehicle.

The vehicle movement controller 240 may control a steering device or a vehicle speed control device of the vehicle. The vehicle movement controller 240 may control each component of the vehicle such that the vehicle drives along the driving path.

For example, when it is determined that the vehicle does not need to change the driving path and the approaching vehicle's intention to change the path is not detected, the driving movement controller 240 may control the vehicle to perform a warning operation with respect to the approaching vehicle.

As another example, when it is determined that the vehicle needs to change the driving path, the vehicle movement controller 240 may calculate an evasive driving path based on road obstacle information. That is, the vehicle movement controller 240 may calculate the evasive driving path by changing the driving path such that the vehicle avoids an approaching vehicle and obstacles existing in the driving path. When a plurality of evasive driving paths are calculated, the vehicle movement controller 240 may preferentially select, as an evasive driving path, a path that requires minimum gear switching of the vehicle. For example, an evasive driving path in which the vehicle can avoid an approaching vehicle by moving forward may be preferentially selected than an evasive driving path in which the vehicle can avoid the approaching vehicle by reversing.

As another example, when a forward movement evasive path is not calculated due to an obstacle or the like, and also, a backward movement evasive path is not calculated due to a neighboring vehicle located behind a user vehicle, the vehicle movement controller 240 may control the vehicle to stop and stand by. In this instance, the vehicle may inform a driver of the situation, and may terminate an autonomous driving mode.

As another example, when an evasive path is not calculated, the approaching vehicle's intention to change the driving path is not detected, and it is determined that the movement of the vehicle and the approaching vehicle does not allow the vehicle to drive any longer, the vehicle movement controller 240 may terminate an autonomous driving mode (driving assist function) according to the present disclosure, and may authorize a driver to have the right to control the vehicle. To this end, the vehicle movement controller 240 may output a notification message in order to inform the driver of the termination of the autonomous driving mode. The notification message may be output via a device that enables the driver to recognize the notification message via the sense of vision, the sense of hearing, the sense of touch, and the like.

As described above, the vehicle control device may enable an autonomous vehicle to continue autonomous driving and to continuously provide the convenience and trust of a driver, when the autonomous vehicle meets various environments.

Hereinafter, detailed operation of the above-described embodiments will be described in detail with reference to drawings.

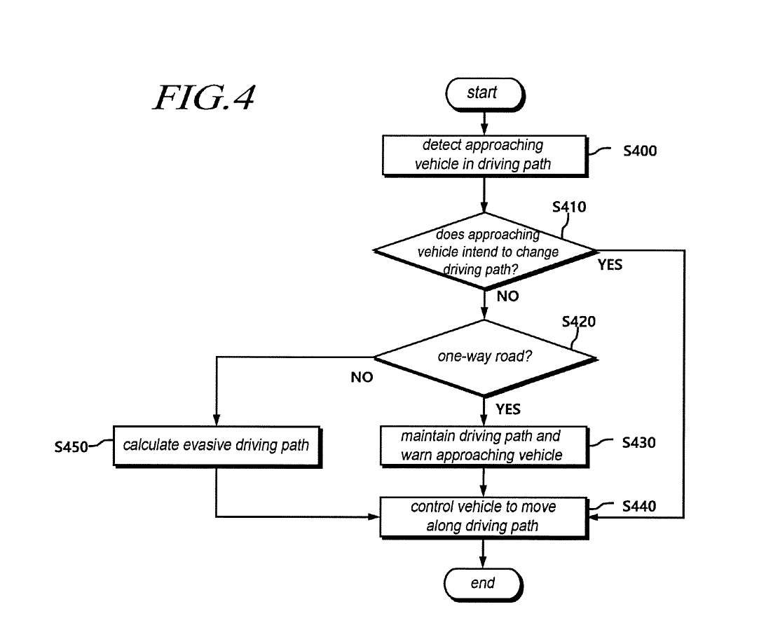

FIG. 4 is a diagram illustrating operation of a vehicle control device according to an embodiment.

Referring to FIG. 4, a vehicle control device may detect an approaching vehicle existing in a driving path according to the above-described method in operation S400. When the approaching vehicle is detected, and the vehicle is capable of driving along a driving path irrespective of the approaching vehicle, the vehicle control device may perform normal autonomous driving control. However, the vehicle may be incapable of driving due to the approaching vehicle on a narrow road or a one-way road, as described above.

In this instance, the vehicle control device may determine whether the approaching vehicle intends to change a driving path in operation S410. For example, the approaching vehicle's intention to change the driving path may be determined based on at least one from among a movement direction of the approaching vehicle, a variation in size of the approaching vehicle, and a variation in the separation distance between the vehicle and the approaching vehicle. Also, as described above, the approaching vehicle's intention to change the driving path may be determined by further reflecting speed information of the user vehicle.

Whether the approaching vehicle intends to change the driving path may be determined at a predetermined point in time for the determination. For example, whether the approaching vehicle intends to change the path may be determined by detecting whether the approaching vehicle reverses/whether the approaching vehicle moves to an evasion space during a predetermined period of time. Here, the predetermined period of time may be set to be the same or different for each situation. For example, when a driving road on which the vehicle meets the approaching vehicle is a one-way road, the predetermined period of time may be set to be shorter than when the road is not a one-way road. That is, various periods of time may be set such that the various periods of time may be mapped to a location where the vehicle is located, road attribute information, and the like.

When it is determined that the approaching vehicle intends to change the driving path, the vehicle maintains its driving path, and may control the movement of the vehicle such that the vehicle drives along the driving path in operation S440. That is, the vehicle control device may not separately perform an operation for calculating an evasive driving path, and may control the vehicle to avoid the approaching vehicle and to drive along the driving path when the approaching vehicle completely performs evasion in the driving path.

Unlike the above, when the approaching vehicle's intention to change the driving path is not detected, the vehicle control device may determine whether the road type of the corresponding road is a one-way road in operation S420. When the corresponding road is different from the one-way road, the vehicle control device may calculate an evasive driving path to be used for avoiding the approaching vehicle in operation S450, and may control the vehicle to drive along the evasive driving path in operation S440. As described above, a path that requires minimum gear switching of the vehicle may be selected as the evasive driving path, whereby the convenience for a driver may be maximized.

When the corresponding road is a one-way road, the vehicle control device may perform a control such that the vehicle keeps the driving path and a warning signal is generated for the approaching vehicle in operation S430. For example, in the case of a one-way road, the vehicle has priority to pass the road, the vehicle may control the headlights, a sound generation device, and the like of the vehicle so as to information the approaching vehicle that the vehicle has priority, and to enable the approaching vehicle to change a driving path. Alternatively, the vehicle control device may transfer information directing the approaching vehicle to change the path, via an inter-vehicle communication device. When the driving path of the approaching vehicle is changed as warning information is generated, the vehicle may control the vehicle move along the set driving path in operation S440.

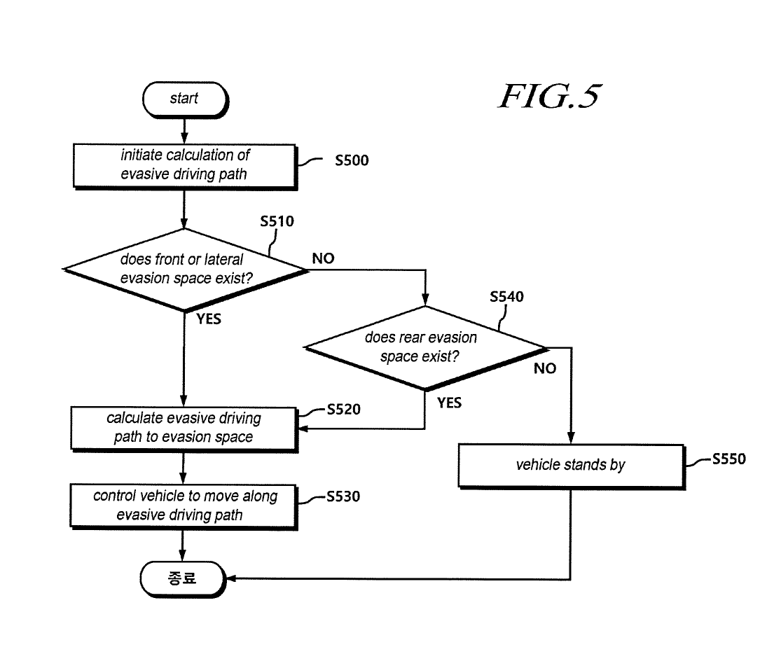

FIG. 5 is a diagram illustrating an operation of calculating an evasive driving path according to an embodiment.

As described above, when an approaching vehicle does not intend to change a path and a road is not a one-way road, a vehicle may calculate an evasive driving path.

Referring to FIG. 5, when it is determined that the vehicle needs to calculate an evasive driving path, the vehicle initiates evasive driving path calculation in operation S500. A process of determining whether to calculate an evasive driving path has been described with reference to FIGS. 2 to 4.

The vehicle control device determines whether an evasion space exists in front of the vehicle or on a lateral side of the vehicle, using a plurality of sensors installed in the vehicle in operation S510. Whether the evasion space exists may be determined based on vehicle information such as the width, length, and the like of the vehicle, the location of an obstacle and obstacle information obtained via sensor installed in the vehicle. For example, the vehicle control device may determine whether a space exists where the vehicle is capable of avoiding the approaching vehicle by moving forward or aside.

When it is determined that an evasion space exists in front of, or on a lateral side of, the vehicle, the vehicle control device may calculate an evasive driving path used for moving the vehicle to the evasion space in operation S520, and may control the vehicle to move the vehicle along the evasive driving path in operation S530.

Unlike the above, when an evasion space does not exist in front of, or on a lateral side of, the vehicle, the vehicle control device may determine whether an evasion space exists behind the vehicle in operation S540. When it is determined that an evasion space exists behind the vehicle, the vehicle control device may calculate an evasive driving path used for moving the vehicle to the evasion space in operation S520, and may control the vehicle to move along the evasive driving path in operation S530. When an evasion space does not exist even behind the vehicle, the vehicle control device may set the vehicle to a standby state in operation S550, and may provide information associated with the situation to a driver of the vehicle or the approaching vehicle. The situation in which an evasion space does not exist behind the vehicle may occur when other vehicles continuously enter. Therefore, the vehicle control device may transfer information associated with the situation occurring in front of them, information leading them to avoid entering, or the like to other vehicles located behind the vehicle via inter-vehicle communication or the like. Through the above, the congestion attributable to the continuous entry of vehicles may be relieved.

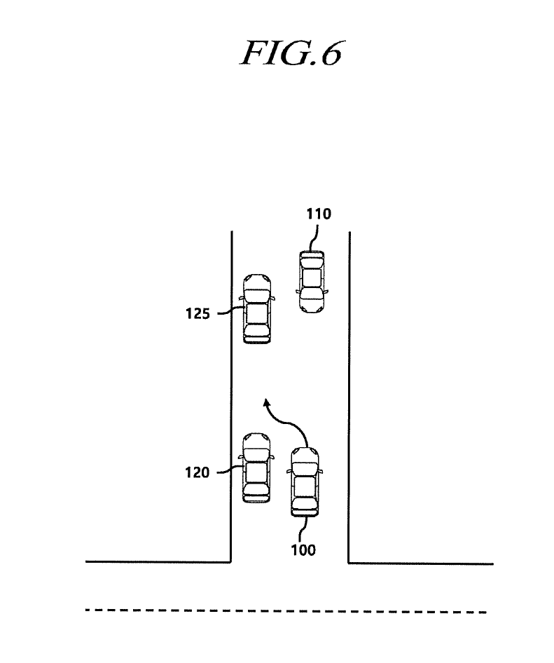

FIG. 6 is a diagram illustrating an operation of controlling a movement of a vehicle according to an evasive driving path according to an embodiment.

Referring to FIG. 6, the vehicle 100 may detect an evasion space between the parked vehicles 120 and 125. As described above, the evasion space may be detected via a camera sensor or a radar sensor. When the evasion space exists in a direction in which the vehicle 100 drives, the vehicle control device may perform a control such that the vehicle 100 moves to the evasion space between the parked vehicles 120 and 125.

Subsequently, after the approaching vehicle 110 passes by, the vehicle control device may control the vehicle 100 to move out of the site between the parked vehicles 120 and 125 and return to the originally set driving path, and may continue autonomous driving.

When it is determined that the space between the parked vehicles 120 and 125 is too small to be an evasion space, the vehicle control device may calculate an evasive driving path to move backward. In the case of a backward movement evasive path, the vehicle 100 needs to perform gear switching in a direction opposite to the original driving direction. Therefore, the backward movement evasive path has a lower priority than that of a forward movement evasive path.

Hereinafter, a vehicle control method that performs all or some of the above-described embodiments will be described with reference to a drawing.

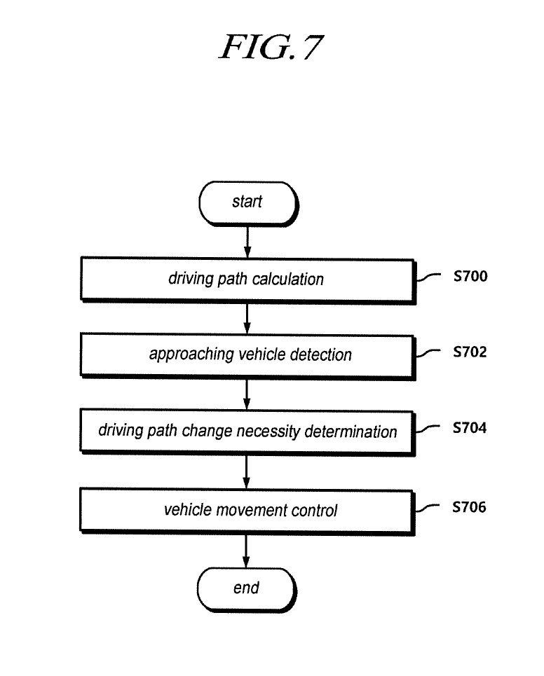

FIG. 7 is a diagram illustrating a vehicle control method according to an embodiment.

Referring to FIG. 7, the vehicle control method may include driving path calculation operation S700 for calculating the driving path of a vehicle based on road attribute information including at least one piece of information from among road type information, obstacle information, and drivable road width information. The vehicle control method may obtain road width information, the location information of the vehicle, and obstacle information via various sensors installed inside or outside the vehicle, and may calculate and obtain the drivable road width information associated with a drivable road width that excludes road obstacles or the like, using the obtained information. Also, the vehicle control method may calculate the driving path in which the vehicle avoids obstacles and autonomously drives, using the obtained road attribute information. The road type information may include information associated with the road type of a road on which the vehicle is located. That is, the road type information may include whether the corresponding road is an alley, a one-way road, or the like.

In addition, the road attribute information may be obtained from a neighboring vehicle or an infrastructure device via a communication device of the vehicle.

Also, the vehicle control method may include an approaching vehicle detection operation S702 for detecting an approaching vehicle that moves in a direction opposite to a direction in which the vehicle drives, in the driving path, while the vehicle drives along the driving path. The approaching vehicle detection operation may detect an approaching vehicle that drives in a direction opposite to the direction in which the vehicle drives, using information received via a sensor of the vehicle, such as a camera sensor, a radar sensor, or the like. For example, the approaching vehicle detection operation may determine whether a neighboring vehicle is an approaching vehicle that drives toward the user vehicle, by obtaining the shape of the headlights of the neighboring vehicle, the shape of the whole or a part of the neighboring vehicle, the shape of light of headlights, the separation distance between the vehicle and the neighboring vehicle, speed information of the neighboring vehicle, and the like. Also, the approaching vehicle detection operation may determine whether the approaching vehicle drives in the driving path of the vehicle.

Also, the vehicle control method may include driving path change necessity determination operation S704 for determining whether the vehicle needs to change the driving path based on the road attribute information and an approaching vehicle's intention to change a driving path. The driving path change necessity determination operation may determine whether the vehicle needs to change the driving path using at least one piece of the road attribute information and the approaching vehicle's intention to change the path.

For example, when the type of road corresponds to a one-way road, the driving path change necessity determination operation may determine that the vehicle does not need to change the driving path and may lead the approaching vehicle to change a driving path.

As another example, when the approaching vehicle's intention to change the path is detected, the driving path change necessity determination operation may determine that the vehicle does not need to change the driving path.

As another example, when the approaching vehicle's intention to change the path is not detected, and the type of road is different from a one-way road, the driving path change necessity determination operation may determine that the vehicle needs to change the driving path.

Here, the driving path change necessity determination operation may determine whether the approaching vehicle intends to change the path based on whether the approaching vehicle performs a reverse control or whether the approaching vehicle changes a driving direction. For example, the driving path change necessity determination operation may determine whether the approaching vehicle needs to change the driving path based on a variation in an image of the whole or a part of the approaching vehicle obtained via a camera sensor. Alternatively, the driving path change necessity determination operation may determine whether the vehicle needs to change the driving path based on a variation in the separation distance between the vehicle and the approaching vehicle obtained via a radar sensor or the like. Alternatively, the approaching vehicle's intention to change the path may be determined based on whether the approaching vehicle moves to an evasion space. In the above-described determination operation, a variation in size or a variation in separation distance may be calculated by taking into consideration the vehicle speed of the vehicle.

As another example, when it is determined that the road type information included in the road attribute information is a one-way road, and the vehicle drives in the wrong direction on the one-way road, the driving path change necessity determination operation may determine that the vehicle needs to change the driving path. In this instance, the driving path change necessity determination operation may determine that the vehicle needs to change the driving path, irrespective of whether the approaching vehicle intends to change the path.

Also, the vehicle control method may include vehicle movement control operation S706 for controlling the movement of the vehicle based on a result of determining the necessity of changing the driving path. The vehicle movement control operation may calculate an evasive driving path in which the vehicle avoids the approaching vehicle and drives, when it is determined that the vehicle needs to change the driving path. The evasive driving path may perform calculation by giving the highest priority to a path in which the vehicle can avoid the approaching vehicle and drives in the driving direction. That is, a path that requires minimum gear switching of the vehicle may be preferentially calculated as the evasive driving path.

Alternatively, in the case in which the vehicle does not need to change the driving path, when the approaching vehicle completes an evasion operation, the vehicle movement control operation may perform a control such that the vehicle drives along the originally set driving path.

Alternatively, when the vehicle does not need to change the driving path and the approaching vehicle does not make an evasive movement, the vehicle movement control operation may perform a control so as to generate a signal that leads the approaching vehicle to make an evasive movement, via a visual and auditory warning device of the vehicle. Alternatively, the vehicle may transfer information that leads the approaching vehicle or other vehicles behind the vehicle to make an evasive movement, via an inter-vehicle communication device.

Alternatively, when an evasive path is not calculated, the approaching vehicle's intention to change the driving path is not detected, or it is determined that the movement of the vehicle and the approaching vehicle does not allow the vehicle to drive any longer, the vehicle movement control operation may terminate an autonomous driving mode (driving assist function) according to the present disclosure, and may authorize a driver to have the right to control the vehicle. To this end, the vehicle movement control operation may output a notification message in order to inform the driver of the termination of the autonomous driving mode.

According to above-described embodiments, when an autonomous vehicle is in a predetermined condition, the autonomous vehicle may continue autonomous driving control and may maintain the convenience and trust of the driver. Also, a driving path may be changed or set by applying priority to drive based on a road type, whereby a vehicle control may be performed, which is similar to a vehicle control performed by a driver.

Even if it was described above that all of the components of an embodiment of the present disclosure are coupled as a single unit or coupled to be operated as a single unit, the present disclosure is not necessarily limited to such an embodiment. That is, at least two elements of all structural elements may be selectively joined and operate without departing from the scope of the present disclosure. The above embodiments of the present disclosure have been described only for illustrative purposes, and those skilled in the art will appreciate that various modifications and changes may be made thereto without departing from the scope and spirit of the disclosure. The scope of the present disclosure shall be construed on the basis of the accompanying claims in such a manner that all of the technical ideas included within the scope equivalent to the claims belong to the present disclosure.

What is claimed is:

1. A vehicle control device, comprising:
a driving path calculator configured to calculate a driving path of a vehicle based on road attribute information comprising at least one piece of information from among road type information, obstacle information, and drivable road width information;
an approaching vehicle detector configured to detect an approaching vehicle which moves in a direction opposite to a direction in which the vehicle drives, in the driving path while the vehicle drives along the driving path;
a driving path change necessity determiner configured to determine a necessity of changing the driving path of the vehicle based on the road attribute information and an approaching vehicle's intention to change a path; and
a vehicle movement controller configured to control a movement of the vehicle based on a result of determining the necessity of changing the driving path.

2. The vehicle control device of claim 1, wherein the road type information comprises at least one piece of information from among road width information and information associated with whether a road is a one-way road.

3. The vehicle control device of claim 1, wherein the driving path change necessity determiner detects whether the approaching vehicle reverses, and determines that the approaching vehicle intends to change the path when it is determined that the approaching vehicle reverses.

4. The vehicle control device of claim 3, wherein the driving path change necessity determiner detects whether the approaching vehicle reverses, using a variation in size of the approaching vehicle sensed by a sensor.

5. The vehicle control device of claim 4, wherein the driving path change necessity determiner detects whether the approaching vehicle reverses, by further using speed information of the vehicle, and a reference size variation used for determining whether the approaching vehicle reverses is set differentially for each speed information of the vehicle.

6. The vehicle control device of claim 3, wherein the driving path change necessity determiner detects whether the approaching vehicle reverses, using a variation in separation distance information between the vehicle and the approaching vehicle sensed by a sensor.

7. The vehicle control device of claim 1, wherein, when it is determined that the approaching vehicle intends to change the path, the driving path change necessity determiner determines that the vehicle does not need to change the driving path.

8. The vehicle control device of claim 1, wherein, when it is determined that a road type of a road from which the vehicle detects the approaching vehicle is a one-way road, the driving path change necessity determiner determines that the vehicle does not need to change the driving path.

9. The vehicle control device of claim 1, wherein, when it is determined that a road type of a road from which the vehicle detects the approaching vehicle is a one-way road, and the vehicle drives in the wrong direction on the one-way road, the driving path change necessity determiner determines that the vehicle needs to change the driving path.

10. The vehicle control device of claim 1, wherein, when the road type is different from a one-way road and the approaching vehicle's intention to change the path is not detected, the driving path change necessity determiner determines that the vehicle needs to change the driving path.

11. The vehicle control device of claim 1, wherein, when an evasion space exists which is calculated based on obstacle information associated with the road, and it is detected that the approaching vehicle moves to the evasion space, the driving path change necessity determiner determines that the approaching vehicle intends to change the path.

12. The vehicle control device of claim 1, wherein, when the driving path needs to be changed, the vehicle movement controller calculates an evasive driving path based on the obstacle information associated with the road.

13. The vehicle control device of claim 12, wherein the vehicle movement controller preferentially calculates, as an evasive driving path, a path that requires minimum gear shifting of the vehicle.

14. The vehicle control device of claim 1, wherein, when the vehicle does not need to change the driving path and the approaching vehicle's intention to change the path is not detected, the vehicle movement controller controls the vehicle so as to perform a warning operation with respect to the approaching vehicle.

15. A vehicle control method, comprising:
a driving path calculation operation to calculate a driving path of a vehicle based on road attribute information comprising at least one piece of information from among road type information, obstacle information, and drivable road width information;
an approaching vehicle detection operation to detect an approaching vehicle that moves in a direction opposite to a direction in which the vehicle drives, in the driving path while the vehicle drives along the driving path;
a driving path change necessity determination operation to determine a necessity of changing the driving path of the vehicle based on the road attribute information and an approaching vehicle's intention to change a path; and
a vehicle movement control operation to control a movement of the vehicle based on a result of determining the necessity of changing the driving path.

16. The vehicle control method of claim 15, wherein the driving path change necessity determination operation detects whether the approaching vehicle reverses, and determines that the approaching vehicle intends to change the path when it is determined that the approaching vehicle reverses.

17. The vehicle control method of claim 15, wherein the driving path change necessity determination operation detects whether the approaching vehicle reverses, using a variation in size of the approaching vehicle sensed by a sensor.

18. The vehicle control method of claim 15, wherein the driving path change necessity determination operation detects whether the approaching vehicle reverses, using a variation in separation distance information between the vehicle and the approaching vehicle sensed by a sensor.
